(19) United States
(12) Patent Application Publication
(10) Pub. No.: US 2026/0253250 A1
(43) Pub. Date: Aug. 27, 2026

(54) UNIFIED METHOD FOR HAND-OBJECT POSE ESTIMATION

(71) Applicant: The Chinese University of Hong Kong, Hong Kong (CN)

(72) Inventors: Pheng-Ann HENG, Hong Kong (CN); Yinqiao WANG, Hong Kong (CN); Hao XU, Hong Kong (CN); Chi-Wing FU, Hong Kong (CN)

(21) Appl. No.: 19/062,684

(22) Filed: Feb. 25, 2025

(51) Int. Cl. G06T 7/73; G06V 10/25; G06V 10/44; G06V 10/80

(52) U.S. Cl. CPC G06T 7/73; G06V 10/25; G06V 10/44; G06V 10/806; G06T 2207/30196

(57) ABSTRACT

A unified method and systems for hand-object pose estimation based on monocular RGB images are provided. The method includes predicting, by an object switcher, a grasping status of an object in an input image to provide flexibility across different scenes; performing adaptive grasp-aware feature fusion for hand-object features to configure effective object information based on the grasping status to maintain robust feature representation for hands; performing generative de-occluding that is a conditional generative step to synthesize plausible de-occluded hand images as pairs for training samples affected by object-induced occlusions, with adaptive adjustment of control strength to produce high-quality samples; and performing multi-level feature enhancement that is a feature learning step that imposes pair-wise constraints between original occluded and generated non-occluded features at multiple levels to promote the network to learn occlusion-invariant features, enabling robust hand pose estimation against severe occlusions.

### BACKGROUND OF THE INVENTION

### 1. Introduction

Estimating the three-dimensional (3D) pose of hand and any potential hand-held objects from monocular images is a longstanding challenge with significant applications in virtual reality (VR)/augmented reality (AR) and human-computer interactions.

### 2. Related Work

Monocular 3D Hand Pose Estimation (HPE): Most methods formulate HPE by regressing MANO coefficients [2-4, 10, 51, 58, 61-64, 66]. Other common representations include voxels [26, 36, 37, 52], implicit functions [25], and meshes [8, 9, 29, 49, 65]. While they achieve superior performance in predicting hand poses, they fail to consider object pose estimation during hand-object interactions, which is critical for practical applications.

Monocular 3D Hand-Object Pose Estimation (HOPE): To estimate the hand and object poses simultaneously, recent works can be categorized into two main streams: (i) template-free methods, which reconstruct objects without knowing their 3D models, and (ii) template-based methods, which assume the 3D object model is known, focusing on regressing its pose. For the first approach, Hasson et al. [19] recovers the object mesh from a deformed icosphere. Tse et al. [45]proposes to optimize hand and object meshes iteratively. More recent works leverage implicit [11, 12, 24, 55, 57] or neural fields [13] to represent the hand and object. Yet, these methods often struggle to accurately model unseen objects due to limited prior data. For the second approach, Liu et al. [32]proposes a semi-supervised learning approach. Lin et al. [31] designs a dual-branch backbone to leverage mutual hand-object information. Although these methods produce promising results, they focus on the hand-object scene, lacking the flexibility to effectively handle the hand-only scenario.

Hand-Object Image Synthesis: Rendering-based methods [15, 19, 54] use common tools [1, 14, 35] to render images as augmented data for HPE and HOPE tasks. With the advance of generative models [16, 21, 42-44, 48], recent methods generate more realistic data for various purposes, including image generation [22, 38, 60], object-prior guidance [56], hand re-malformation [33], and training data augmentation [40, 50].

As illustrated in FIG. 1, hand pose estimation (HPE) methods [5, 9, 25, 36, 39, 49, 65] predict the 3D hand pose without considering the hand-held object. On the other hand, hand-object pose estimation (HOPE) methods [18, 19, 31, 32, 47] assume the presence of a hand-held object and perform object pose estimation with an extra object branch. Nevertheless, both methods make predictions even in the absence of an object. Neither approach offers the flexibility to handle both hand-only and hand-object scenarios.

Table 1 provides a detailed analysis of the performance of state-of-the-art (SOTA) HPE methods [39, 49, 65] and HOPE methods [18, 31]. An obvious performance degradation is observed when these methods are applied across different scenes (see “Hand-Only↔Hand-Object Scene”) due to their task-specific designs. Although training on all scenes helps, it negatively impacts their original task performance (see “All→Hand-Only Hand-Object Scene”), revealing their limited generalization capabilities. This observation motivates the need for a unified approach that can effectively adapt to both hand-only and hand-object scenes.

### BRIEF SUMMARY OF THE INVENTION

Embodiments of the subject invention pertain to a unified method and systems for hand-object pose estimation.

According to an embodiment of the subject invention, a unified method for hand-object pose estimation based on monocular RGB images is provided. The method comprises predicting, by an object switcher, a grasping status of an object in an input image to provide flexibility across different scenes; performing adaptive grasp-aware feature fusion for hand-object features to configure effective object information based on the grasping status to maintain robust feature representation for hands; performing generative de-occluding that is a conditional generative step to synthesize plausible de-occluded hand images as pairs for training samples affected by object-induced occlusions, with adaptive adjustment of control strength to produce high-quality samples; and performing multi-level feature enhancement that is a feature learning step that imposes pair-wise constraints between original occluded and generated non-occluded features at multiple levels to promote the network to learn occlusion-invariant features, enabling robust hand pose estimation against severe occlusions. The object switcher is a lightweight multi-layer perceptron (MLP) that feeds in object features. The object features are extracted by a Feature Pyramid Network (FPN) from the input image. Moreover, a training process is supervised according to a binary cross-entropy loss with respect to ground-truth grasping labels. During a testing process, an object pose estimation branch is deactivated if it is predicted as non-grasping. The performing adaptive grasp-aware feature fusion comprises mitigating interference from irrelevant features by configuring most pertinent object features for enhancing hand representations. The object features and the hand features produced by a region of interest align (RoIAlign) operation is concatenated only when the object is predicted as grasped. The concatenated features are processed through a multi-head attention block to generate fused hand-object features for subsequent network to regress three-dimensional (3D) hand poses. During a training process, the performing generative de-occluding comprises synthesizing plausible de-occluded hand images as pairs for training samples affected by object-caused occlusions. The performing generative de-occluding further comprises performing an adaptive adjustment method for control strength to maximize generation quality. Furthermore, the performing multi-level feature enhancement comprises imposing pair-wise constraints between original occluded and generated non-occluded features at three different levels. The three different levels include an initial level, a region of interest (RoI) level, and a MANO level to promote the network to simulate occlusion-invariant features via self-distillation, enabling a robust performance of hand pose estimation against object-caused occlusion during a testing process.

In another embodiment of the subject invention, a unified system for hand-object pose estimation based on monocular RGB images is provided. The system comprises an object switcher module configured to predict a grasping status of an object in an input image to provide flexibility across different scenes; an adaptive grasp-aware feature fusion module configured for hand-object features to obtain effective object information based on the grasping status to maintain robust feature representation for hands; a generative de-occluding module configured to synthesize plausible de-occluded hand images as pairs for training samples affected by object-induced occlusions, with adaptive adjustment of control strength to produce high-quality samples; and a multi-level feature enhancement module configured to impose pair-wise constraints between original occluded and generated non-occluded features at multiple levels to promote the network to learn occlusion-invariant features, enabling robust hand pose estimation against severe occlusions. The object switcher module is a lightweight multi-layer perceptron (MLP) that feeds in object features. Moreover, the object features are extracted by a Feature Pyramid Network (FPN) from the input image. The training process is supervised based on binary cross-entropy loss with respect to ground-truth grasping labels. During a testing process, an object pose estimation branch is deactivated if it is predicted as non-grasping. Furthermore, the performing adaptive grasp-aware feature fusion module comprises mitigating interference from irrelevant features by configuring most pertinent object features for enhancing hand representations. The object features and the hand features produced by a region of interest align (RoIAlign) operation is concatenated only when the object is predicted as grasped. In addition, the concatenated feature is processed through a multi-head attention block to generate fused hand-object features for subsequent network to regress three-dimensional (3D) hand poses.

### BRIEF DESCRIPTION OF THE DRAWINGS

FIG. 1 shows the convention approaches (top) for 3D hand pose estimation based on either Hand Pose Estimation (HPE), which predicts hand pose only, or Hand-Object Pose Estimation (HOPE), which assumes hand-held object, and the UniHOPE approach (bottom) of the subject invention offering flexibility and robustness to handle both scenes in a unified manner.

FIG. 2 shows the UniHOPE framework of the subjection invention, demonstrating that (i) hand images occluded by objects to form pairs are first de-occluded, conditioned on the depth map and hand-object mask, with adaptive selection of control strength to produce high-quality samples; (ii) to accommodate both hand-only and hand-object scenes, the object switcher dynamically controls the object output by predicting grasping status, which guides the feature fusion module to eliminate irrelevant object features; and (iii) to robustly estimate hand pose, the multi-level feature enhancement techniques utilize paired data to learn occlusion-invariant hand features, according to an embodiment of the subject invention.

FIG. 3 shows de-occluded exemplary images in various occlusion conditions, according to an embodiment of the subject invention.

FIG. 4 shows visualization of the adaptive control strength adjustment, according to an embodiment of the subject invention.

FIGS. 5A-5D show qualitative comparison between the method of the subject invention and the SOTA HPE/HOPE methods on hand-only/hand-object scenarios across different datasets, wherein the first and second rows in each example denote the original view and another view, respectively, for better comparison, according to an embodiment of the subject invention.

FIG. 6 shows plot diagrams demonstrating joint AUC comparison under different thresholds, wherein the UniHOPE method consistently achieves better performance than other methods, according to an embodiment of the subject invention.

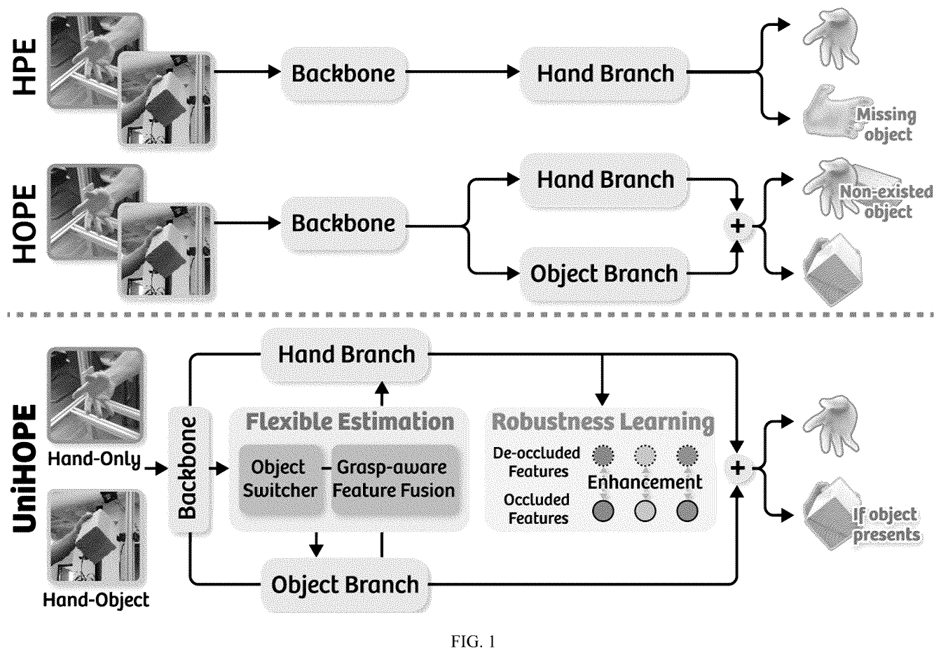

| | Hand- | | Hand-Only → | | All → Hand- | | All → Hand- | |
|---|---|---|---|---|---|---|---|---|
| | Only Scene | | Hand-Object Scene | | Only Scene | | Object Scene | |
| HPE | J-PE ↓ | V-PE ↓ | J-PE ↓ | V-PE ↓ | J-PE ↓ | V-PE ↓ | J-PE ↓ | V-PE ↓ |
| HandOccNet [39] | 12.98 | 12.52 | 19.60 (−6.62) | 18.95 (−6.43) | 13.16 (−0.18) | 12.70 (−0.18) | 14.58 | 14.10 |
| H2ONet [49] | 13.34 | 13.13 | 21.98 (−8.64) | 21.42 (−8.30) | 14.14 (−0.80) | 14.00 (−0.87) | 15.20 | 15.03 |
| SimpleHand [65] | 14.05 | 13.51 | 18.37 (−4.32) | 17.54 (−4.03) | 14.63 (−0.58) | 13.96 (−0.45) | 14.88 | 14.21 |

| | Hand- | | Hand-Object → | | All → Hand- | | All → Hand- | |
|---|---|---|---|---|---|---|---|---|
| | Object Scene | | Hand-Only Scene | | Object Scene | | Only Scene | |
| HOPE | J-PE ↓ | V-PE ↓ | J-PE ↓ | V-PE ↓ | J-PE ↓ | V-PE ↓ | J-PE ↓ | V-PE ↓ |
| Keypoint Trans. [18] | 17.99 | 17.57 | 25.10 (−7.11) | 24.40 (−6.83) | 18.79 (−1.00) | 18.35 (−0.78) | 19.75 | 19.26 |
| HFL-Net [31] | 14.61 | 14.13 | 19.39 (−4.78) | 18.61 (−4.48) | 14.77 (−0.16) | 14.29 (−0.16) | 13.61 | 13.10 |

TABLE 1 shows the conventional HPE methods trained on hand-only scene exhibit obvious performance degradation when testing on hand-object scene (1 st vs. 2nd columns). Though training on all scenes (3rd & 4th columns) helps to improve metrics on the hand-object scene (2nd vs. 4th columns), their original performance is adversely affected (1st vs. 3rd columns). The HOPE methods also exhibit a similar pattern (see bottom part). These results demonstrate the inabilities of the existing methods to flexibly handle hand-only and hand-object scenes altogether.

| | | All Scenes | | | | Hand-Only Scene | | |
|---|---|---|---|---|---|---|---|---|
| | Methods | J-PE ↓ | PA-J-PE ↓ | V-PE ↓ | PA-V-PE ↓ | J-PE ↓ | PA-J-PE ↓ | V-PE ↓ |
| HPE | HandOccNet [39] | 14.02 | 6.17 | 13.55 | 5.95 | 13.16 | 5.31 | 12.70 |
| | MobRecon [9] | 15.02 | 6.71 | 13.93 | 5.91 | 14.43 | 5.88 | 13.45 |
| | H2ONet [49] | 14.78 | 5.72 | 14.63 | 6.19 | 14.14 | 4.74 | 14.00 |
| | SimpleHand [65] | 14.78 | 6.30 | 14.11 | 6.03 | 14.63 | 5.62 | 13.96 |
| HOPE | Lju et al. [32] | 15.33 | 6.17 | 14.79 | 5.98 | 15.18 | 5.48 | 14.60 |
| | Keypoint Trans. [18] | 19.16 | 7.70 | 18.71 | 7.96 | 19.75 | 7.59 | 19.26 |
| | HFL-Net [31] | 14.32 | 6.08 | 13.83 | 5.86 | 13.61 | 5.20 | 13.10 |
| Unified | H2ONet^{‡} + | 14.12 | 5.83 | 13.75 | 5.83 | 13.29 | 4.70 | 13.08 |
| | HFL-Net^{‡} | | | | | | | |
| | H2ONet^{‡} + | 14.54 | 5.90 | 14.19 | 6.00 | 14.14 | 4.76 | 14.00 |
| | HFL-Net^{‡} | | | | | | | |
| | HandOccNet^{‡} + | 14.34 | 6.06 | 13.86 | 5.85 | 13.85 | 5.28 | 13.35 |
| | HFL-Net^{‡} | | | | | | | |
| | HandOccNet^{‡} + | 14.52 | 6.15 | 14.02 | 5.93 | 14.09 | 5.37 | 13.58 |
| | HFL-Net^{‡} | | | | | | | |
| | UniHOPE (ours) | 13.03 | 5.59 | 12.59 | 5.40 | 12.59 | 4.83 | 12.12 |

| | | Hand-Only Scene | Hand-Object Scene | | | |
|---|---|---|---|---|---|---|
| | Methods | PA-V-PE ↓ | J-PE ↓ | PA-J-PE ↓ | V-PE ↓ | PA-V-PE ↓ |
| HPE | HandOccNet [39] | 5.11 | 14.58 | 6.73 | 14.10 | 6.49 |
| | MobRecon [9] | 5.15 | 15.40 | 7.25 | 14.24 | 6.39 |
| | H2ONet (49] | 5.35 | 15.20 | 6.35 | 15.03 | 6.74 |
| | SimpleHand [65] | 5.38 | 14.88 | 6.74 | 14.21 | 6.45 |
| HOPE | Lju et al. [32] | 5.31 | 15.43 | 6.61 | 14.91 | 6.40 |
| | Keypoint Trans. [18] | 7.98 | 18.79 | 7.77 | 18.35 | 7.94 |
| | HFL-Net [31] | 5.01 | 14.77 | 6.64 | 14.29 | 6.41 |
| Unified | H2ONet^{‡} + | 5.06 | 14.66 | 6.55 | 14.18 | 6.33 |
| | HEL-Net^{‡} | | | | | |
| | H20Net^{‡} + | 5.35 | 14.79 | 6.63 | 14.31 | 6.41 |
| | HFL-Net^{‡} | | | | | |
| | HandOccNet^{‡} + | 5.08 | 14.66 | 6.56 | 14.18 | 6.34 |
| | HPL-Net^{‡} | | | | | |
| | HandOccNet^{‡} + | 5.17 | 14.79 | 6.65 | 14.31 | 6.42 |
| | HFL-Net^{‡} | | | | | |
| | UniHOPE (ours) | 4.66 | 13.31 | 6.08 | 12.89 | 5.87 |

TABLE 2 shows hand-pose estimation results on DexYCB. †: pre-trained in the original setting. ‡: re-trained in the unified setting. The best and second-best are marked in bold and underlined. The UniHOPE method of the subject invention attains leading performance for almost all metrics in all scenarios.

| | gelatin_ | bleach_ | wood_ | |
|---|---|---|---|---|
| Methods | box | cleanser | block | average ↑ |
| Lio et al. [32] | 26.31 | 25.07 | 68.56 | 38.89 |
| Keypoint Trans. [18] | 0.00 | 1.31 | 32.61 | 10.47 |
| HEL-Net [31] | 25.88 | 32.08 | 70.16 | 41.59 |
| H2ONet^{†} + HFL-Net^{†} | 29.26 | 30.71 | 64.84 | 40.69 |
| H2ONet^{‡} + HFL-Net^{‡} | 26.12 | 29.33 | 69.40 | 40.51 |
| HandOccNet^{†} + HFL-Net^{†} | 29.30 | 30.57 | 64.94 | 40.69 |
| HandOccNet^{‡} + HFL-Net^{‡} | 26.22 | 29.51 | 69.40 | 40.61 |
| UniHOPE (ours) | 26.23 | 32.32 | 74.29 | 43.06 |

TABLE 3 shows unseen object-pose estimation results on DexYCB.

| | Methods | J-PE ↓ | J-AUC ↑ | V-PE ↓ | V-AUC ↑ | F@5 ↑ | F@15 ↑ |
|---|---|---|---|---|---|---|---|
| HPE | HandOccNet [39] | 28.94 | 47.96 | 28.10 | 49.23 | 23.34 | 67.86 |
| | MobRecon [9] | 29.61 | 48.10 | 28.65 | 49.59 | 23.38 | 67.72 |
| | H2ONet \|49] | 30.46 | 47.09 | 29.55 | 48.31 | 22.10 | 66.04 |
| | Simple Hand [65] | 29.01 | 47.58 | 28.09 | 49.00 | 21.93 | 65.90 |
| HOPE | Liu et al. [32] | 29.54 | 47.55 | 28.66 | 48.83 | 21.82 | 67.34 |
| | Keypoint Trans. [18] | 41.04 | 34.47 | 39.64 | 36.02 | 17.13 | 56.07 |
| | HFL-Net [31] | 28.45 | 50.34 | 27.55 | 51.57 | 24.31 | 69.88 |
| Unified | H2ONet^{‡} + | 31.27 | 47.70 | 30.33 | 48.86 | 22.91 | 67.20 |
| | HFL-Net^{‡} | | | | | | |
| | H2ONet^{‡} + | 28.49 | 50.45 | 27.59 | 51.67 | 24.33 | 69.86 |
| | HFL-Net^{‡} | | | | | | |
| | HandOccNet^{‡} + | 30.96 | 47.85 | 30.01 | 49.02 | 23.04 | 67.47 |
| | HPL-Net^{‡} | | | | | | |
| | HandOccNet^{‡} + | 28.33 | 50.45 | 27.44 | 51.67 | 24.39 | 69.99 |
| | HFL-Net^{‡} | | | | | | |
| | UMHOPE (ours) | 26.23 | 52.26 | 25.41 | 53.52 | 24.64 | 70.77 |

TABLE 4 shows hand-pose estimation results (Root-relative) on HO3D.

| | | Root-relative | | | | | |
|---|---|---|---|---|---|---|---|
| | Methods | J-PE ↓ | J-AUC ↑ | V-PE ↓ | V-AUC ↑ | F@5 ↑ | F@15 ↑ |
| HPE | HandOccNet [39] | 58.03 | 29.07 | 56.06 | 29.40 | 14.89 | 47.75 |
| | MobRecon [9] | 71.18 | 22.21 | 68.50 | 22.34 | 10.41 | 36.67 |
| | H2ONet [49] | 79.14 | 19.88 | 76.29 | 19.38 | 9.69 | 36.71 |
| | SimpleHand [65] | 60.82 | 26.09 | 58.85 | 26.34 | 12.84 | 43.53 |
| HOPE | Lju et al. [32\| | 59.40 | 28.84 | 57.39 | 29.04 | 14.92 | 47.76 |
| | Keypoint Trans. [18] | 96.27 | 13.60 | 93.39 | 12.37 | 6.99 | 27.82 |
| | HFL-Net [31] | 58.02 | 29.94 | 56.08 | 30.20 | 15.47 | 48.83 |
| Unified | H2ONet^{‡} + | 68.88 | 24.27 | 66.49 | 24.21 | 12.33 | 42.38 |
| | HFL-Net^{‡} | | | | | | |
| | H2ONet^{‡} + | 68.25 | 24.49 | 65.90 | 24.40 | 12.30 | 42.51 |
| | HFL-Net^{‡} | | | | | | |
| | HandOccNet^{‡} + | 81.79 | 21.33 | 78.91 | 20.56 | 10.89 | 36.68 |
| | HFL-Net^{‡} | | | | | | |
| | HandOccNet^{‡} + | 80.74 | 20.30 | 78.00 | 19.44 | 10.52 | 36.38 |
| | HFL-Net^{‡} | | | | | | |
| | UniHOPE (ours) | 50.97 | 34.31 | 49.21 | 34.94 | 17.83 | 53.46 |
| | | Procrustes Alignment | | | | | |
| | Methods | J-PE ↓ | J-AUC ↑ | V-PE ↓ | V-AUC ↑ | F@5 ↑ | F@15 ↑ |
| HPE | HandOecNet [39] | 14.52 | 71.34 | 14.09 | 72.07 | 40.02 | 88.08 |
| | MobRecon [9] | 17.74 | 65.16 | 17.32 | 65.90 | 32.95 | 81.35 |
| | H2ONet [49] | 14.56 | 71.21 | 14.25 | 71.69 | 38.73 | 87.69 |
| | SimpleHand [65] | 15.79 | 68.90 | 15.37 | 69.61 | 37.03 | 85.40 |
| HOPE | Lju et al. [32\| | 14.00 | 72.30 | 13.59 | 73.02 | 41.53 | 89.11 |
| | Keypoint Trans. [18] | 16.97 | 66.66 | 17.03 | 66.38 | 34.31 | 83.44 |
| | HFL-Net [31] | 14.29 | 71.75 | 13.85 | 72.52 | 40.52 | 88.63 |
| Unified | H2ONet^{‡} + | 14.47 | 71.36 | 14.10 | 71.99 | 39.48 | 88.14 |
| | HFL-Net^{‡} | | | | | | |
| | H2ONet^{‡} + | 14.42 | 71.47 | 14.06 | 72.09 | 39.54 | 88.18 |
| | HFL-Net^{‡} | | | | | | |
| | HandOccNet^{‡} + | 15.40 | 69.65 | 14.85 | 70.58 | 38.30 | 86.94 |
| | HFL-Net^{‡} | | | | | | |
| | HandOccNet^{‡} + | 16.15 | 68.29 | 15.58 | 69.26 | 36.92 | 85.93 |
| | HFL-Net^{‡} | | | | | | |
| | UniHOPE (ours) | 13.53 | 73.24 | 13.14 | 73.92 | 43.23 | 89.55 |

TABLE 5 shows cross-dataset validation of hand-pose estimation on FreiHAND.

| | Occlusion (25%-50%) | | | | Occlusion (50%-75%) | | |
|---|---|---|---|---|---|---|---|
| Methods | J-PE↓ | PA-J-PE↓ | V-PE ↓ | PA-V-PE ↓ | J-PE↓ | PA-J-PE↓ | V-PE ↓ |
| HandOccNet [39} | 16.40 | 7.08 | 15.85 | 6.83 | 18.22 | 7.60 | 17.67 |
| MobRecon [9] | 16.67 | 7.61 | 15.60 | 6.77 | 20.04 | 8.17 | 18.80 |
| H2ONet [49] | 17.07 | 6.76 | 16.78 | 7.09 | 19.41 | 7.32 | 19.07 |
| SimpleHand [65] | 16.43 | 7.05 | 15.78 | 6.75 | 19.33 | 7.55 | 18.38 |
| Liu et al. [32] | 16.98 | 6.92 | 16.43 | 6.71 | 19.72 | 7.11 | 19.14 |
| Keypoint Trans. [18] | 20.95 | 8.15 | 20.41 | 8.31 | 24.45 | 8.61 | 23.88 |
| HFL-Net [31] | 16.33 | 7.00 | 15.81 | 6.77 | 18.66 | 7.33 | 18.11 |
| H2ONet^{‡} + | 16.07 | 6.84 | 15.57 | 6.67 | 19.39 | 7.40 | 18.82 |
| HFL-Net^{‡} | | | | | | | |
| H2ONet^{‡} + | 16.43 | 6.93 | 15.94 | 6.79 | 18.76 | 7.29 | 18.25 |
| HFL-Net^{‡} | | | | | | | |
| HandOceNet^{‡} + | 16.04 | 6.89 | 15.53 | 6.65 | 19.22 | 7.43 | 18.64 |
| HFL-Net^{‡} | | | | | | | |
| HandOccNet^{‡} + | 16.41 | 7.00 | 15.88 | 6.77 | 18.64 | 7.33 | 18.09 |
| HFL-Net^{‡} | | | | | | | |
| UniHOPE (ours) | 14.59 | 6.39 | 14.13 | 6.17 | 16.27 | 6.51 | 15.78 |

| | Occlusion | | | | |
|---|---|---|---|---|---|
| | (50%-75%) | Occlusion (75%-100%) | | | |
| Methods | PA-V-PE ↓ | J-PE↓ | PA-J-PE↓ | V-PE ↓ | PA-V-PE ↓ |
| HandOccNet [39} | 7.33 | 28.15 | 8.71 | 27.20 | 8.40 |
| MobRecon [9] | 7.48 | 31.46 | 9.64 | 29.97 | 9.23 |
| H2ONet [49] | 7.58 | 31.07 | 8.82 | 30.11 | 8.94 |
| SimpleHand [65] | 7.39 | 38.52 | 10.57 | 36.85 | 10.40 |
| Liu et al. [32] | 6.91 | 33.80 | 8.99 | 32.64 | 8.71 |
| Keypoint Trans. [18] | 8.76 | 38.29 | 11.21 | 37.39 | 11.75 |
| HFL-Net [31] | 7.11 | 28.95 | 8.80 | 27.94 | 8.53 |
| H2ONet^{‡} + | 7.22 | 30.32 | 8.43 | 29.27 | 8.28 |
| HFL-Net^{‡} | | | | | |
| H2ONet^{‡} + | 7.14 | 31.02 | 8.55 | 29.91 | 8.45 |
| HFL-Net^{‡} | | | | | |
| HandOceNet^{‡} + | 7.20 | 29.57 | 8.58 | 28.53 | 8.31 |
| HFL-Net^{‡} | | | | | |
| HandOccNet^{‡} + | 7.10 | 29.22 | 8.76 | 28.20 | 8.47 |
| HFL-Net^{‡} | | | | | |
| UniHOPE (ours) | 6.29 | 26.42 | 7.64 | 25.51 | 7.40 |

TABLE 6 shows comparison with SOTA methods across different object-caused occlusion levels on DexYCB.

| | | Root-relative | | Procrustes Align. | |
|---|---|---|---|---|---|
| | Models | J-PE ↓ | V-PE ↓ | J-PE ↓ | V-PE ↓ |
| (a) | Baseline | 14.09 | 13.61 | 5.95 | 5.75 |
| (b) | w/Grasp-aware Feature Fusion | 13.84 | 13.37 | 5.79 | 5.58 |
| (c) | w/Generative De-occluder | 13.38 | 12.92 | 5.71 | 5.52 |
| (d) | +Image Feature Enhancement | 13.23 | 12.79 | 5.64 | 5.44 |
| (e) | +Rol Feature Enhancement | 13.18 | 12.73 | 5.64 | 5.45 |
| (f) | +MANO Feature Enhancement | 13.12 | 12.67 | 5.63 | 5.43 |
| (g) | +Occlusion-aware Case Filtering | 13.03 | 12.59 | 5.59 | 5.40 |

TABLE 7 shows ablation study on major designs in UniHOPE.

### DETAILED DISCLOSURE OF THE INVENTION

Embodiments of the subject invention are directed to a unified method and systems for hand-object pose estimation based on monocular RGB images.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

### 3. Method

### 3.1. Overview

A UniHOPE method is provided to unify HPE and HOPE by addressing (i) basic criteria: adaptively switching between the hand-only and hand-object scenes; and (ii) advanced criteria: robustly estimate hand pose, regardless of whether an object is present.

First, to meet the basic criteria, the hand pose must always be predicted regardless of whether the hand is grasping an object, while the object pose should be estimated only if the object is present. Though a straightforward solution is to manually select the existing SOTA HPE and HOPE methods according to the input scene, this approach is suboptimal, as switching between models leads to incoherent results and inhibits joint optimization for one model to work on both scenes.

Importantly, an end-to-end method is employed to dynamically control object pose estimation through an internal object switcher by estimating the confidence of the grasping status. This approach enhances compatibility across various scenarios.

However, solely adopting the existing network architectures along with the object switcher of the subject invention encounters another issue caused by the commonly used hand object information interaction structure [31, 32, 45]. When no object is present, extracting object features is unnecessary. Thus, irrelevant object-to-hand feature transitions compromise hand pose estimation accuracy. To overcome this issue, a grasp-aware feature fusion module is formulated to utilize grasping confidence to select effective object features in hand-object feature fusion.

Second, the advanced criteria emphasize coherent and robust hand pose estimation, regardless of whether the hand is grasping an object. As hand-held objects frequently cause severe occlusions, it is essential to learn occlusion-invariant features to accurately recover hand poses. Ideally, the feature of a non-occluded hand serves as the optimal representation for an occluded hand with the same pose, as it simplifies the prediction difficulty.

To achieve this objective, the model is trained by transferring knowledge from the corresponding non-occluded hands to the occluded ones. Given the scarcity of such paired data, diffusion-based generative models are leveraged to create realistic de-occluded hand images from the originally occluded ones.

Subsequently, the multi-level feature enhancement techniques are adopted to assist the network to simulate occlusion-invariant features by utilizing information from the de-occluded hand images in a self-distillation framework.

The key advantages of the embodiments of the subject invention are summarized as follows:
A unified solution is provided for hand-object pose estimation, with UniHOPE serving as a versatile approach to handle general hand-object scenarios.
An internal object switcher offers flexibility across different scenes and a grasp-aware feature fusion module is formulated to adaptively utilize the effective object information based on grasping status.
An occlusion-invariant feature learning strategy is introduced for robustness, first using a generative de-occluder to prepare paired de-occluded hand images, and then applying feature enhancement at multiple levels for robustness.
Extensive experiments on three widely used datasets in the unified setting demonstrate the SOTA performance of UniHOPE.

Estimating the 3D pose of hand and potential hand-held object from monocular images is a longstanding challenge. Yet, the existing methods are specialized, focusing on either barehand or hand interacting with object. No method can flexibly handle both scenarios, and their performance degrades when applied to the other scenario.

According to the embodiments of the subject invention, Uni-HOPE, a unified method is provided for general 3D hand-object pose estimation, flexibly adapting both scenarios. In particular, a grasp-aware feature fusion module is designed to integrate hand-object features with an object switcher to dynamically control the hand-object pose estimation according to grasping status. Further, to improve the robustness of hand pose estimation regardless of object presence, realistic de-occluded image pairs are generated to train the model to learn object induced hand occlusions and formulate multi-level feature enhancement techniques for learning occlusion-invariant features. In addition, extensive experiments on three commonly used benchmarks demonstrate UniHOPE's SOTA performance in addressing hand-only and hand-object scenarios.

In contrast to the existing techniques, the embodiments of the subject invention address a more general scenario and may consistently predict the hand pose, whether the hand is grasping an object. If an object is present, the model additionally estimates its pose.

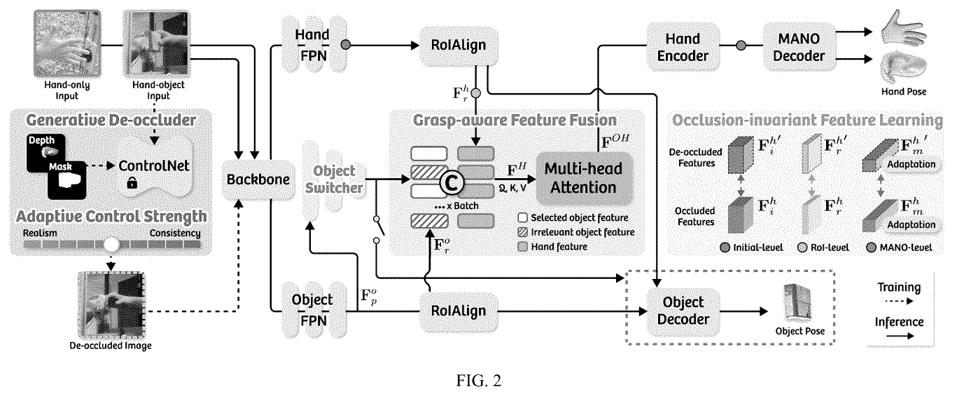

FIG. 2 shows the pipeline of the UniHOPE method of the subject invention. First, to dynamically estimate hand-object pose in an end-to-end manner, where the object switcher is configured to flexibly control the output and the grasp-aware feature fusion module integrates grasp-relevant object information (refer to Section 3.2). Next, to improve robustness against occlusions, a generative de-occluder is generated to prepare high quality paired data by adaptively adjusting control strengths, which is then used to learn occlusion-invariant features through the multi-level feature enhancement methods of the subject invention (refer to Section 3.3). Finally, the loss functions are performed as discussed in Section 3.4.

### 3.2. Dynamic Hand-Object Pose Estimation

To accommodate both HPE and HOPE, it is essential to consistently predict hand poses while estimating object poses only when an object is present. Directly combining the existing HPE and HOPE methods is insufficient due to the incoherence introduced by model switching and the lack of joint optimization. In this section, the end-to-end dynamic hand-object pose estimation method is presented. To flexibly control the object output, an object switcher is introduced for predicting grasping status and is trained with automatically generated labels. Further, a grasp-aware feature fusion module is provided and guided by the grasping status to inhibit object-to-hand irrelevant feature transitions when no object is present.

Grasping Label Preparation. To support model training, the grasping status labels are automatically prepared, as the existing datasets [6, 17] do not provide this information. The isotropic Relative Rotation Error (RRE) and Relative Translation Error (RTE) between the object poses in the initial and current frames are computed as shown in Equation (1):

$$RRE = arccos ( \frac{trace ( {ξ}_{R}^{t ⊤} {ξ}_{R}^{0} - 1 )}{2} ) , RTE = {‖ {ξ}_{T}^{t} - {ξ}_{T}^{0} ‖}_{2} , \qquad ( 1 )$$

where ξ_{R}∈ [symbol] and ξ_{T}∈ [symbol] denote the object rotation matrix and translation vector, respectively. The superscripts 0 and t indicate the frame indexes. The object is labeled as grasped if the computed errors exceed a defined threshold value.

Object Switcher: With the prepared labels, a multi-layer perceptron (MLP) g(⋅) is employed to predict the grasping status from the object feature

$${F}_{p}^{o}$$

which is extracted by the Feature Pyramid Network (FPN) [30] from the input image. This process is supervised by the binary cross-entropy loss as shown by Equation (2):

$${ℒ}^{s} = - {\sum }_{j = 0}^{1} \text{?} ( \hat{G} = j ) \cdot log \frac{exp ( {g ( {F}_{p}^{o} )}_{j} )}{{\sum }_{k = 0}^{1} exp ( {g ( {F}_{p}^{o} )}_{k} )} , \qquad ( 2 )$$

where Ĝ is the ground-truth grasping label and [symbol] (⋅) is the indicator function. During the testing, the object pose estimation branch is deactivated if predicted as non-grasping, providing more accurate responses for hand-object interactions.

Grasp-aware Feature Fusion: Previous studies have shown that feature interaction between hand and object can effectively enhance performance in hand-object scenes [31, 32, 45]. However, such interaction can disrupt hand feature learning in the hand-only scene due to the absence of objects (see Table 1). To mitigate interference from irrelevant object features, the grasp-aware feature fusion is employed. During the training, the object feature

$${F}_{r}^{o}$$

and the hand feature

$${F}_{r}^{h}$$

produced by RoIAlign [20] are concatenated to form the feature F^{H} only when the object is predicted as grasped. Next, F^{H} is processed through a multi-head attention block [46], resulting in the fused hand-object feature F^{OH} as shown by Equation (3):

$${F}^{H} = Concat ( {F}_{r}^{h} , {sF}_{r}^{o} + ( 1 - s ) {F}_{r}^{h} ) and \qquad ( 3 )$$

$${F}^{OH} = Soft max ( \frac{{F}^{H} {F}^{{H}^{T}}}{\sqrt{{d}^{H}}} ) {F}^{H} ,$$

where

$$s = Arg max ( g ( {F}_{p}^{o} ) )$$

indicates the predicted grasping status. Concat(⋅) and Softmax (⋅) represent the concatenation and soft-max operations along the channel dimension, respectively. d^{H} is the channel dimension of F^{H}. This approach enables the network to flexibly toggle object outputs while maintaining robust feature representations for the hand across various scenes. Then, F^{OH} is fed into an hourglass-structured hand encoder to produce MANO-related features and regress two-dimensional (2D) hand joint coordinates.

### 3.3. Occlusion-Invariant Feature Learning

Hands are frequently occluded when interacting with objects. To achieve robust estimation, the extracted hand feature for the same hand pose should be occlusion-invariant and irrespective of object presence. Given the fact that estimating the bare hand pose is easier than that of the one occluded by a held object, the key insight is to enable the network to simulate the non-occluded hand features from the occluded ones by transferring cross-domain knowledge. Thus, plausible de-occluded hand images are generated as pairs for training samples affected by object-caused occlusions, employing an adaptive adjustment strategy for control strength to maximize generation quality. Further, multi-level feature enhancement techniques are provided, leveraging the paired data to promote comprehensive hand feature learning.

Generative De-occluder: For occluded hand images, the goal is to de-occlude by realistically removing the grasped object while preserving the hand pose to create paired data. ControlNet is adopted and pre-trained on synthetic hand images, to repaint the hand-object region M guided by a rendered hand depth map D. Specifically, following the latent diffusion model [42], the original image X is first projected into latent space as x₀ using a variational auto-encoder [27]. Then, the standard forward diffusion process as outlined in [21] is followed. In each reverse step t∈{T, T−1, . . . , 1}, to preserve the known background region (1−M)⊙X, the corresponding feature can be alternated using (1−m)⊙xₜ as long as maintaining the correct properties of its distribution, as the transition from xₜ to xₜ₋₁ depends solely on xₜ, as shown by Equation (4),

$${x}_{t - 1}^{bg} \sim 𝒩 ( \sqrt{{\overline{α}}_{t}} {x}_{0} , ( 1 - {\overline{α}}_{t} I ) ) , \qquad ( 4 )$$

where m is down sampled from M for calculations in latent space, and ⊙ is the element-wise product. [symbol] (⋅) denotes the Gaussian distribution. α̅ₜ denotes the total noise variance at step t, as defined in [44]. For the unknown hand-object region M⊙X, the reverse diffusion process is performed using the DDIM sampler [44], as shown in Equation (5),

$${x}_{t - 1}^{ho} = DDIM ( {ϵ}_{θ} ( {x}_{t} , {x}_{mask} , D ) ) , \qquad ( 5 )$$

where xₘₐₛₖ is the latent feature masked by m. ϵ_{θ}(⋅) denotes the denoising model. Thus, the final expression of xₜ₋₁ during one reverse step is shown by Equation (6),

$${x}_{t - 1} = m ⊙ {x}_{t - 1}^{ho} + ( 1 - m ) ⊙ {x}_{t - 1}^{bg} , \qquad ( 6 )$$

which mean

$${x}_{t - 1}^{bg}$$

is sampled using the known background pixels, while

$${x}_{t - 1}^{ho}$$

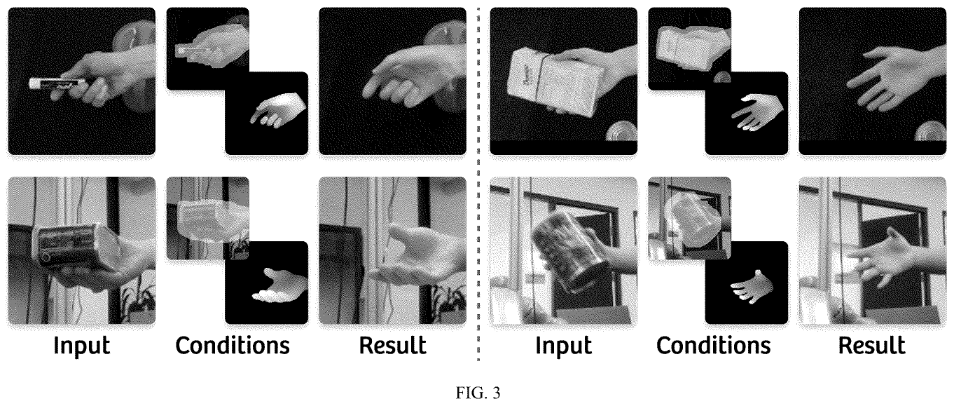

is sampled from the bare-hand data distribution. They are combined into the new xₜ₋₁ using the hand-object mask, ensuring both consistency and realism. After the iterative reverse process, the final denoised vector x₀ is sent to the decoder [27] to recover images from latent features. Examples of different occlusion conditions are shown along with their de-occluded counterparts in FIG. 3.

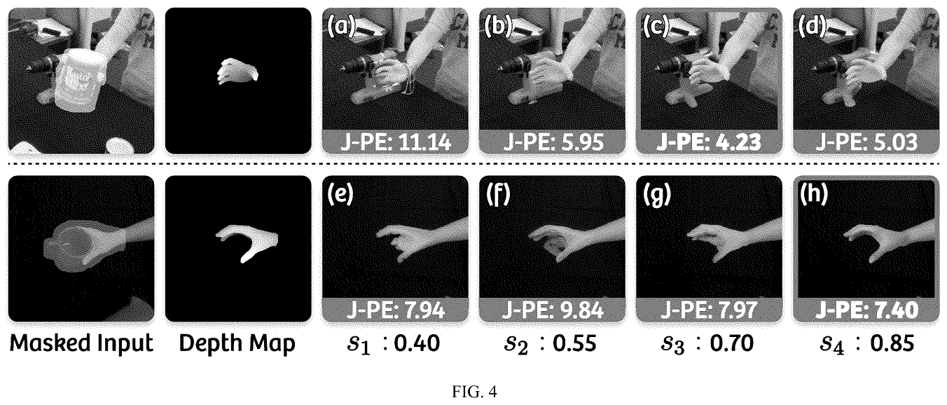

Adaptive Control Strength Adjustment: To balance consistency with the condition and realism of the generated hand images, the user often needs to manually adjust the control strength parameter in the generative model. some examples generated using different control strengths are visualized in FIG. 4. In certain cases, such as the top row, too-small control strengths make the generated hand not align well with the depth condition as shown in panels (a) and (b) of FIG. 4, while overly large strengths result in unrealistic appearances as shown in panel (d) of FIG. 4. Conversely, in other cases like the bottom row, a large control strength is needed to ensure correct hand anatomy as shown in panel (h) of FIG. 4. Therefore, a fixed control strength cannot be universally applied, while manually setting the value for each case is impractical. To this end, the control strength to enhance generation quality is adaptively and automatically adjusted. Specifically, candidate control strengths {s₁, s₂, . . . , sₙ|0<sᵢ≤1, ∀i} are first defined and n corresponding images are generated. Then, a pre-trained hand reconstruction model from [9] is employed to estimate the 3D hand mesh in the generated images and evaluate the metric against the ground truth. The generated sample with the optimal metric is incorporated into the training process with the same ground-truth labels as the original sample. For example, panels (c) and (h) of FIG. 4 are selected based on the lowest J-PE. This method maximizes the generation quality by selecting a proper control strength that best balances realism and consistency for each case.

Multi-level Feature Enhancement: Given the pair of the original image and the corresponding generated image (X,X′), the goal is to enhance the hand feature representation of X by leveraging information from X′. To achieve this, pair-wise feature constraints are introduced within a single network in a self-distillation manner. To holistically enhance the capability of recovering occluded information for hand, as shown in FIG. 2, hand features throughout the hand branch at multiple levels are enhanced: (i) The initial-level feature

$${F}_{i}^{h} ,$$

extracted from the initial layer of the FPN, captures the low-level information of the hand; (ii) the RoI-level feature

$${F}_{r}^{h}$$

output from the FPN after the RoIAlign operation, is utilized for adaptive fusion with the object feature; and (iii) the MANO-level feature

$${F}_{m}^{h} ,$$

extracted before the MANO decoder, serves as the most pertinent feature for regressing the MANO coefficients. Since the MANO-level feature is at a relatively late stage, the occluded and de-occluded counterparts may not always reside in a similar feature space. Inspired by [7], a multi-head attention block h(⋅) is adopted as the adaptation layer to improve knowledge transfer. Overall, the feature enhancement constraints are formulated as the L1 loss between the features of X and X, as shown in Equation (7),

$$\begin{matrix}{ℒ}_{init}^{enh} = {‖ {F}_{i}^{h} - {F}_{i}^{{h}^{′}} ‖}_{1} , {ℒ}_{RoI}^{enh} = {‖ {F}_{r}^{h} - {F}_{r}^{{h}^{′}} ‖}_{1} , \\ and {ℒ}_{MANO}^{enh} = {‖ h ( {F}_{m}^{h} ) - h ( {F}_{m}^{{h}^{′}} ) ‖}_{1} ,\end{matrix} \qquad ( 7 )$$

where features with primes belong to the generated image.

Occlusion-aware Case Filtering: During the knowledge transition from the generated samples to the original ones, it is observed that the feature learning process may not benefit if the original hand is already non-occluded. In this case, the knowledge gap between de-occluded and occluded hand features disappears, which causes the feature constraints to focus on mitigating the sim-to-real domain gap, making the original features close to the simulated ones, thus yielding suboptimal performance. To address this issue, non-occluded samples are filtered out for paired feature enhancement. Specifically, the Intersection over Union (IoU) of the provided amodal hand mask (considering object-caused occlusions) and the rendered full hand mask as the ground-truth occlusion proportion are computed. During the training, feature constraints are exclusively applied to pairs whose original occlusion proportion Ô exceeds a pre-defined threshold τ. Furthermore, non-grasping samples are excluded as they do not contribute additional information. Thus, the feature enhancement is conducted only on grasping and occluded samples, as shown in Equation (8),

$${ℒ}_{*}^{enh} = 𝕝 ( ( O \geq 𝒯 ) \hat{} ( \hat{G} = 1 ) ) \cdot {ℒ}_{*}^{enh} , \qquad ( 8 )$$

where τ=0.1 in the experiments. [symbol] represents the feature enhancement constraints at multiple levels.

### 3.4. Loss Functions

The training loss includes regular hand and object losses similar to [31], along with the object switcher loss [symbol] , and feature enhancement constraints [symbol] , [symbol] , and [symbol] . First, the hand loss is computed as [symbol] , as shown in Equation (9),

$$\begin{matrix}{ℒ}^{J} = {‖ {J}^{2 D} - {\hat{J}}^{2 D} ‖}_{2} + {‖ {J}^{3 D} - {\hat{J}}^{3 D} ‖}_{2} , \\ {ℒ}^{V} = {‖ V - \hat{V} ‖}_{2} , and {ℒ}^{MANO} = {‖ ( θ ; β ) - ( \hat{θ} ; \hat{β} ) ‖}_{2} .\end{matrix} \qquad ( 9 )$$

Herein J^{2D}, J^{3D}, and V represent the 2D joint, 3D joint, and 3D vertex coordinates, respectively. (θ; β) represent the MANO coefficients. The hat superscript denotes the ground-truth label. The object loss [symbol] supervises the predictions of the 2D location (projected from 3D object key points) and their corresponding confidences from image grid proposals [41], as shown in Equation (10),

$${ℒ}^{o} = {\sum }_{g} {{\sum }^{{N}^{o}}}_{k = 1} ( {‖ {p}_{g , k} - {\hat{p}}_{p , k} ‖}_{1} + {‖ {c}_{g , k} - {\hat{c}}_{g , k} ‖}_{1} ) , \qquad ( 10 )$$

where N^{o} is the number of key points in the 3D bounding box of object mesh. p_{g,k} and c_{g,k} are the pixel location and confidence value at the grid g and control point k, respectively. The hat superscript denotes the ground truth. the object loss is computed only for those grasping images, as they contain the complete object for pose estimation. Overall, the training loss is defined by Equation (11),

$$\begin{matrix}{ℒ}^{total} = \begin{matrix}\underbrace{{ℒ}^{h} + {ℒ}^{o} + α {ℒ}^{s}} \\ sample - wise\end{matrix} \\ + \begin{matrix}\underbrace{{γ}_{init} {ℒ}_{init}^{enh} + {γ}_{RoI} {ℒ}_{RoI}^{enh} + {γ}_{MANO} {ℒ}_{MANO}^{enh}} \\ pair - wise\end{matrix}\end{matrix} \qquad ( 11 )$$

where α and γ_{*} are weights to balance the loss terms.

### 4. Experiments

### 4.1. Experimental Settings

Datasets. In the unified setting, the original dataset is organized into hand-only and hand-object scenes based on the object grasping status. Experiments are conducted on the following commonly used datasets: (i) DexYCB [6]: the more challenging “S3” split (train/test: 376,374/76,360 samples) is used with unseen grasped objects in the test set (train/test: 15/3 objects). Performance on the entire dataset (all scenes) as well as separately for hand-only and hand-object scenes are reported; (ii) HO3D [17](version 2, train/test: 66,034/11,524 samples): results are submitted to the online server as the ground-truth 3D hand annotations are not publicly accessible, hence results for each scene are unavailable. Further, to evaluate the generalization ability, cross-dataset validation is performed on the test set of (iii) FreiHAND [66](train/test: 130,240/3,960 samples), which mainly comprises bare-hand images and lacks object annotations for scene division. Consequently, results for each scene are also unavailable. More details and results on other data splits of DexYCB are provided in the Supp.

Following are examples that illustrate procedures for practicing the invention. These examples should not be construed as limiting. All percentages are by weight and all solvent mixture proportions are by volume unless otherwise noted.

### Example 1—Evaluation Metrics

Hand pose estimation is evaluated using commonly-used metrics, as in [9, 39, 49]: (i) J/VPE denotes the joint/vertex position error in mm measured by the average Euclidean distance between estimated and ground-truth 3D hand joint/vertex coordinates; (ii) J/V-AUC calculates the area under the curve of the percentage of correct keypoints (PCK) across different error thresholds for joint/vertex; and (iii) F@5/F@15 is the harmonic mean of recall and precision between estimated and ground-truth 3D hand vertices under 5 mm/15 mm thresholds. Besides, these metrics are reported after Procrustes Alignment (PA), i.e., which aligns the estimated results with ground truths through global orientation, translation, and scale adjustment. For object pose evaluation, the Average 3D Distance (ADD) of the grasped object is measured. For DexYCB, ADD-0.5D is reported, the percentage of objects whose ADD is within 50% of the object diameter as in [23] due to the challenge of unseen-object pose estimation. For HO3D, [31, 32] are followed to report ADD-0.1D [53](10% diameter).

### Example 2—Implementation Details

UniHOPE is trained on eight NVidia RTX 2080Ti GPUs using a batch size of 64 and the Adam optimizer [28] with an initial learning rate of 1e-4 (decay by 0.7 every 10 epochs). Input images are resized to 128×128 and augmented with random scaling, rotating, and color jittering. To stabilize training, the network is first trained with original and generated images for 30 epochs, then incorporate the feature enhancement constraints for another 40 epochs.

4.2. Comparison with SOTA Methods

The UniHOPE is compared with the conventional SOTA HPE and HOPE methods [9, 18, 32, 39, 65] in the unified setting (trained using their officially released code). To support the unified task, one straightforward approach is to use a classifier to determine whether the hand is grasping any object. Based on the classification, an existing HPE or HOPE method can be employed accordingly. The combination is denoted as A+B, where A is the SOTA HPE method H2ONet [49] or HandOccNet [39], and B is the SOTA HOPE method, HFL-Net [31].

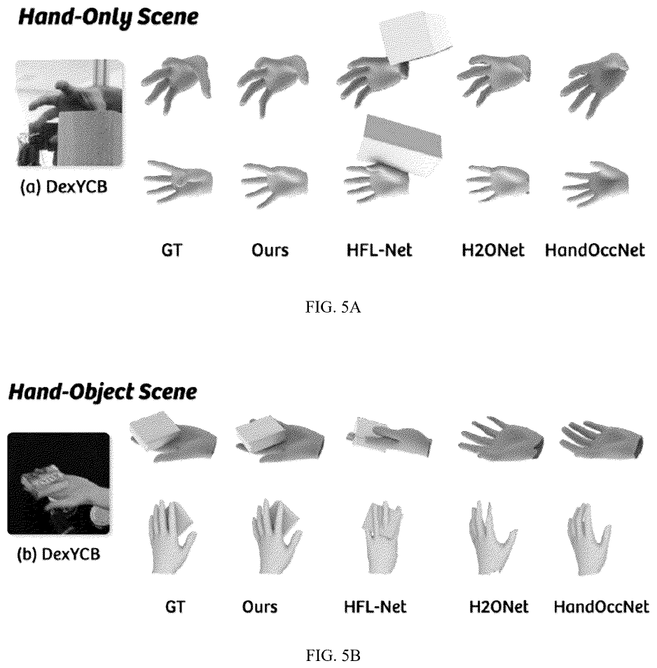

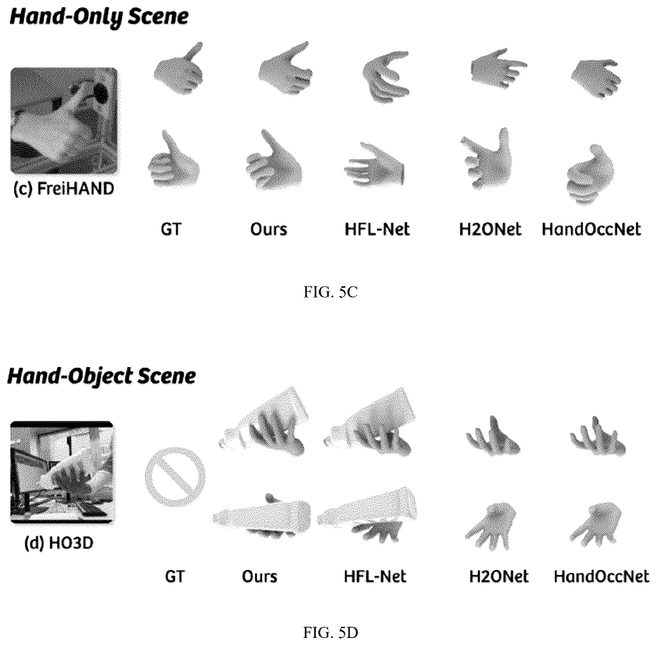

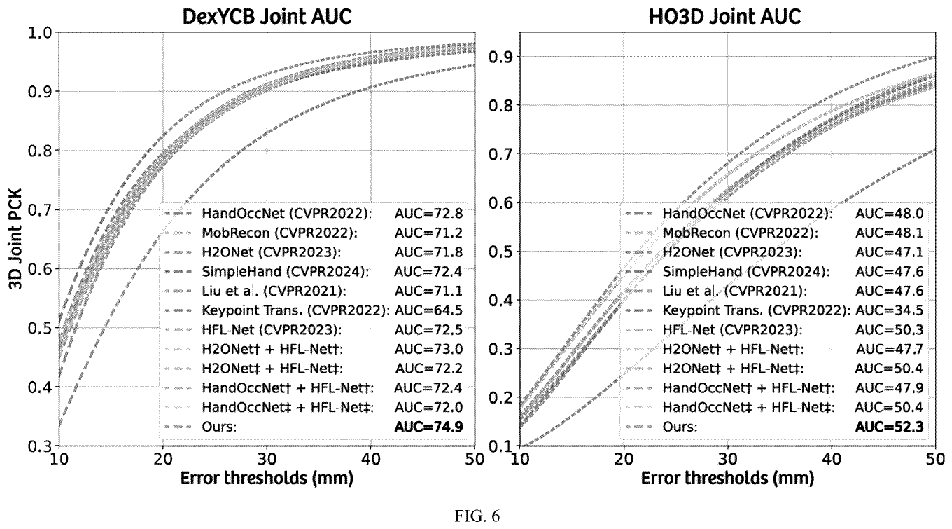

Evaluation on DexYCB. Quantitative comparisons of hand pose estimation on DexYCB in Table 2 are provided. The UniHOPE method achieves the best performance overall, showing its effectiveness in general hand-object interactions across various scenarios. The root-relative 3D joint PCK/AUC comparison under different thresholds is shown in FIG. 6, further confirming the comprehensive performance of the approach of the subject invention. For object pose estimation accuracy, comparisons are conducted using per-instance and average ADD-0.5D, as shown in Tab. 3. Compared with SOTA HOPE methods, the method of the subject invention achieves the highest average score on the test set with unseen objects, highlighting its superiority in estimating object pose. Qualitative comparisons with SOTA methods [31, 39, 49] are illustrated in FIGS. 5A-5D. In the hand-only scenario as shown in FIG. 5A, where the wood block has not yet been grasped, SOTA HOPE method [31] inevitably produces an extra object pose due to its inflexibility. In contrast, the method of the subject invention avoids this issue, thanks to the object switcher's grasping status prediction accuracy exceeding 95%. Moreover, the method of the subject invention yields more plausible hand poses. In the hand-object scenario as shown in FIG. 5B, the method of the subject invention produces high-quality hand-object poses, whereas the conventional methods fail when the hand experiences moderate occlusion, indicating the robustness of the methods of the subject invention against such challenges.

Evaluation on HO3D. The same experiments are conducted on HO3D [17]. Table 4 shows the root-relative quantitative comparison. The method of the subject invention achieves top performance across all metrics, demonstrating its effectiveness and robustness. The joint PCK/AUC curve in FIG. 6 also confirms the consistent best results of the approach of the subject invention. In addition, qualitative comparisons in FIG. 5D clearly illustrate the superiority of the method of the subject invention in estimating 3D hand and object pose under partial object-caused occlusion.

Evaluation on FreiHAND. To assess generalization ability, cross-dataset validation is performed by transferring models trained on DexYCB to the FreiHAND test set. As reported in Table 5, the method of the subject invention outperforms all SOTA HPE/HOPE methods, particularly by a substantial margin in root-relative metrics. The qualitative comparison in FIG. 5C also shows that UniHOPE produces more accurate hand poses in challenging cases, indicating improved generalization to unseen bare-hand scenes.

Evaluation under Different Levels of Occlusion. To showcase the robustness of the method of the subject invention against object-caused occlusion, the DexYCB test set is partitioned to different occlusion levels based on the ground-truth hand-object occlusion proportion (as detailed in Section 3.3) and provide quantitative comparisons in Table 6. The UniHOPE method of the subject invention exhibits the best hand pose estimation performance across all occlusion levels, underscoring the efficacy of the feature enhancement methods of the subject invention. It is noted that test samples where the hand being absent from the image region are excluded.

### 4.3. Ablation Studies

Ablation studies are performed on DexYCB to evaluate the effectiveness of the methods of the subject invention, as shown in Table 7. HFL-Net [31] with the object switcher of the subject invention serves as the simplest baseline.

Grasp-aware Feature Fusion. First the impact of the grasp-aware feature fusion module is analyzed. Comparison of Rows (a-b) shows performance boosts across all metrics, indicating that integrating irrelevant object features affects hand pose estimation and the methods of the subject invention alleviate this issue.

Generative De-occluder. Next, the effects of de-occluded hand images are assessed with in-distribution hand poses, as they provide extra information. Comparing Rows (bc), the notable improvement upon incorporating paired data indicates the effectiveness of synthetic samples.

Occlusion-invariant Feature Learning. Further, the individual effects of feature enhancement at various levels are shown. Comparing Row (c) with (d-f), a progressive improvement in root-relative metrics at each level is shown, demonstrating the efficacy of knowledge transferring from de-occluded hands. Finally, Row (g) reveals that the effects are maximally realized through the occlusion-aware case filtering of the subject invention.

The UniHOPE method and systems may be utilized in a wide range of applications, including, but not limited to:

### (1) VR/AR/XR Device:

In AR/VR/XR environments, the UniHOPE method of the subject invention may enable more immersive and interactive experiences by providing real-time hand-object pose tracking and interaction with both virtual and physical objects. Whether the user is interacting with objects or simply using their hands without any objects, the system ensures accurate and responsive pose estimation, enhancing user experience and interaction realism.

(2) Entertainment and Gaming:

The UniHOPE method of the subject invention can be integrated into gaming systems and interactive entertainment, where precise hand-object pose tracking is essential for controlling virtual objects, navigating menus, or engaging in realistic virtual interactions. This technology would improve gesture-based controls, hand tracking for character animations, and object manipulation in games.

(3) Medical Fields:

In healthcare and rehabilitation, the UniHOPE method of the subject invention can be used in systems that require accurate hand-object pose estimation for physical therapy and prosthetics. For example, it could enable more precise tracking of hand movements together with the grasping object for rehabilitation exercises. In hospitals or medical schools, flexible and accurate pose estimation of surgical tools such as knives and scissors enable the surgeon to switch between different tools with a robust hand tracking performance, thus benefiting preoperative training and surgery simulation for training, diagnosing or teleoperation purposes.

(4) Education and Training:

The UniHOPE method of the subject invention can also be applied in educational tools and training simulators, where hand-object interaction is critical. In fields such as industrial training, arts, and design, users can practice complex tasks virtually with accurate hand pose and object manipulation, improving learning outcomes and skill acquisition.

(5) Robotics:

The UniHOPE method of the subject invention can enhance the accuracy of human-robot interaction systems, allowing robots to interpret and respond to human hand gestures and interactions with objects in dynamic environments. This is especially useful in collaborative tasks involving robots and humans, such as in warehouses, logistics, or drone control.

(6) Human-Computer Interaction Services:

The UniHOPE method of the subject invention could improve gesture-based controls for user interfaces, enabling more intuitive and natural ways of interacting with computers and devices. It could be applied in touchless control or systems where traditional input methods like keyboards and mice are not feasible.

According to the embodiments of the subject invention, UniHOPE, a unified approach for hand-object pose estimation is provided to handle both hand-only and hand-object scenes. The advantages are twofold: first, to enable flexibility in switching between different scenes, an object switcher is incorporated to control object-pose estimation and design a grasping-aware feature fusion module to selectively capture effective object features; second, to promote robustness against object-caused occlusion, multi-level feature enhancement is provided to learn occlusion-invariant hand features from generated realistic de-occluded hand images. Experimental results on three common benchmarks manifest the SOTA performance of UniHOPE.

Embodiment 1. A unified method for hand-object pose estimation based on monocular RGB images, comprising:
predicting, by an object switcher, a grasping status of an object in an input image to provide flexibility across different scenes;
performing adaptive grasp-aware feature fusion for hand-object features to configure effective object information based on the grasping status to maintain robust feature representation for hands;
performing generative de-occluding that is a conditional generative step to synthesize plausible de-occluded hand images as pairs for training samples affected by object-induced occlusions, with adaptive adjustment of control strength to produce high-quality samples; and
performing multi-level feature enhancement that is a feature learning step that imposes pair-wise constraints between original occluded and generated non-occluded features at multiple levels to promote the network to learn occlusion-invariant features, enabling robust hand pose estimation against severe occlusions.

Embodiment 2. The method of embodiment 1, wherein the object switcher is a lightweight multi-layer perceptron (MLP) that feeds in object features.

Embodiment 3. The method of embodiment 2, wherein the object features are extracted by a Feature Pyramid Network (FPN) from the input image.

Embodiment 4. The method of embodiment 2, wherein a training process is supervised according to a binary cross-entropy loss with respect to ground-truth grasping labels.

Embodiment 5. The method of embodiment 2, wherein during a testing process, an object pose estimation branch is deactivated if it is predicted as non-grasping.

Embodiment 6. The method of embodiment 1, wherein the performing adaptive grasp-aware feature fusion comprises mitigating interference from irrelevant features by configuring most pertinent object features for enhancing hand representations.

Embodiment 7. The method of embodiment 6, wherein the object features and the hand features produced by a region of interest align (RoIAlign) operation are concatenated only when the object is predicted as grasped.

Embodiment 8. The method of embodiment 7, wherein the concatenated features are processed through a multi-head attention block to generate fused hand-object features for subsequent network to regress three-dimensional (3D) hand poses.

Embodiment 9. The method of embodiment 1, wherein the performing generative de-occluding comprises synthesizing plausible de-occluded hand images as pairs for training samples affected by object-caused occlusions.

Embodiment 10. The method of embodiment 9, wherein the performing generative de-occluding further comprises performing an adaptive adjustment method for control strength to maximize generation quality.

Embodiment 11. The method of embodiment 1, wherein during a training process, the performing multi-level feature enhancement comprises imposing pair-wise constraints between original occluded and generated non-occluded features at three different levels.

Embodiment 12. The method of embodiment 11, wherein the three different levels include an initial level, a region of interest (RoI) level, and a MANO level to promote the network to simulate occlusion-invariant features via self-distillation, enabling a robust performance of hand pose estimation against object-caused occlusion during a testing process.

Embodiment 13. A unified system for hand-object pose estimation based on monocular RGB images, comprising:
an object switcher module configured to predict a grasping status of an object in an input image to provide flexibility across different scenes;
an adaptive grasp-aware feature fusion module configured for hand-object features to obtain effective object information based on the grasping status to maintain robust feature representation for hands;
a generative de-occluding module configured to synthesize plausible de-occluded hand images as pairs for training samples affected by object-induced occlusions, with adaptive adjustment of control strength to produce high-quality samples; and
a multi-level feature enhancement module configured to impose pair-wise constraints between original occluded and generated non-occluded features at multiple levels to promote the network to learn occlusion-invariant features, enabling robust hand pose estimation against severe occlusions.

Embodiment 14. The system of embodiment 13, wherein the object switcher module is a lightweight multi-layer perceptron (MLP) that feeds in object features.

Embodiment 15. The system of embodiment 14, wherein the object features are extracted by a Feature Pyramid Network (FPN) from the input image.

Embodiment 16. The system of embodiment 14, wherein the training process is supervised based on binary cross-entropy loss with respect to ground-truth grasping labels.

Embodiment 17. The system of embodiment 14, wherein during a testing process an object pose estimation branch is deactivated if it is predicted as non-grasping.

Embodiment 18. The system of embodiment 13, wherein the performing adaptive grasp-aware feature fusion module comprises mitigating interference from irrelevant features by configuring most pertinent object features for enhancing hand representations.

Embodiment 19. The system of embodiment 18, wherein the object features and the hand features produced by a region of interest align (RoIAlign) operation are concatenated only when the object is predicted as grasped.

Embodiment 20. The system of embodiment 19, wherein the concatenated feature is processed through a multi-head attention block to generate fused hand-object features for subsequent network to regress three-dimensional (3D) hand poses.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] Autodesk, INC. Maya. https:/autodesk.com/maya, 2018. 2
[2] Seungryul Baek, Kwang In Kim, and Tae-Kyun Kim. Pushing the envelope for RGB-based dense 3D hand pose estimation via neural rendering. In CVPR, pages 1067-1076, 2019. 2
[3] Seungryul Baek, Kwang In Kim, and Tae-Kyun Kim. Weakly supervised domain adaptation via GAN and mesh model for estimating 3D hand poses interacting objects. In CVPR, pages 6121-6131, 2020.
[4] Adnane Boukhayma, Rodrigo de Bem, and Philip H.S. Torr. 3D hand shape and pose from images in the wild. In CVPR, pages 10843-10852, 2019. 2
[5] Zhe Cao, Ilija Radosavovic, Angjoo Kanazawa, and Jitendra Malik. Reconstructing hand-object interactions in the wild. In ICCV, pages 12417-12426, 2021. 1
[6] Yu-Wei Chao, Wei Yang, Yu Xiang, Pavlo Molchanov, Ankur Handa, Jonathan Tremblay,
Yashraj S Narang, Karl Van Wyk, Umar Iqbal, Stan Birchfield, et al. DexYCB: A benchmark for capturing hand grasping of objects. In CVPR, pages 9044-9053, 2021. 3, 6
[7] Guobin Chen, Wongun Choi, Xiang Yu, Tony Han, and Manmohan Chandraker. Learning efficient object detection models with knowledge distillation. NeurIPS, 30, 2017. 5
[8] Xingyu Chen, Yufeng Liu, Chongyang Ma, Jianlong Chang, Huayan Wang, Tian Chen, Xiaoyan Guo, Pengfei Wan, and Wen Zheng. Camera-space hand mesh recovery via semantic aggregation and adaptive 2D-1D registration. In CVPR, pages 13274-13283, 2021. 2
[9] Xingyu Chen, Yufeng Liu, Yajiao Dong, Xiong Zhang, Chongyang Ma, Yanmin Xiong, Yuan Zhang, and Xiaoyan Guo. MobRecon: Mobile-friendly hand mesh reconstruction from monocular image. In CVPR, pages 20544-20554, 2022. 1, 2, 4, 6, 8
[10] Yujin Chen, Zhigang Tu, Di Kang, Linchao Bao, Ying Zhang, Xuefei Zhe, Ruizhi Chen, and Junsong Yuan. Model-based 3D hand reconstruction via self-supervised learning. In CVPR, pages 10451-10460, 2021. 2
[11] Zerui Chen, Yana Hasson, Cordelia Schmid, and Ivan Laptev. Alignsdf: Pose-aligned signed distance fields for hand-object reconstruction. In ECCV, pages 231-248. Springer, 2022. 2
[12] Zerui Chen, Shizhe Chen, Cordelia Schmid, and Ivan Laptev. gsdf: Geometry-driven signed distance functions for 3d handobject reconstruction. In CVPR, pages 12890-12900, 2023. 2
[13] Hongsuk Choi, Nikhil Chavan-Dafle, Jiacheng Yuan, Volkan Isler, and Hyunsoo Park. Handnerf: Learning to reconstruct hand-object interaction scene from a single rgb image. In ICRA, pages 13940-13946. IEEE, 2024. 2
[14] Blender Online Community. Blender. http://www.blender.org, 2019. 2
[15] Enric Corona, Albert Pumarola, Guillem Alenya, Francesc Moreno-Noguer, and Gregory Rogez. Ganhand: Predicting human grasp affordances in multi-object scenes. In CVPR, pages 5031-5041, 2020. 2
[16] Ian Goodfellow, Jean Pouget-Abadie, Mehdi Mirza, Bing Xu, David Warde-Farley, Sherjil Ozair, Aaron Courville, and Yoshua Bengio. Generative adversarial networks. Communications of the ACM, 63(11):139-144, 2020. 2
[17] Shreyas Hampali, Mahdi Rad, Markus Oberweger, and Vincent Lepetit. Honnotate: A method for 3d annotation of hand and object poses. In CVPR, pages 3196-3206, 2020. 3, 6, 7
[18] Shreyas Hampali, Sayan Deb Sarkar, Mahdi Rad, and Vincent Lepetit. Keypoint transformer: Solving joint identification in challenging hands and object interactions for accurate 3d pose estimation. In CVPR, pages 11090-11100, 2022. 1, 2, 6, 8
[19] Yana Hasson, Gül Varol, Dimitrios Tzionas, Igor Kalevatykh, Michael J. Black, Ivan Laptev, and Cordelia Schmid. Learning joint reconstruction of hands and manipulated objects. In CVPR, pages 11807-11816, 2019. 1, 2
[20] Kaiming He, Georgia Gkioxari, Piotr Dollir, and Ross Girshick. Mask r-cnn. In ICCV, pages 2961-2969, 2017. 4
[21] Jonathan Ho, Ajay Jain, and Pieter Abbeel. Denoising diffusion probabilistic models. In NeurIPS, pages 6840-6851, 2020. 2, 4
[22] Hezhen Hu, Weilun Wang, Wengang Zhou, and Houqiang Li. Hand-object interaction image generation. NeurIPS, 35: 23805-23817, 2022. 3
[23] Yinlin Hu, Pascal Fua, and Mathieu Salzmann. Perspective flow aggregation for data-limited 6d object pose estimation. In ECCV, pages 89-106. Springer, 2022. 6
[24] Di Huang, Xiaopeng Ji, Xingyi He, Jiaming Sun, Tong He, Qing Shuai, Wanli Ouyang, and Xiaowei Zhou. Reconstructing hand-held objects from monocular video. In SIGGRAPH Asia 2022 Conference Papers, pages 1-9, 2022. 2
[25] Lin Huang, Chung-Ching Lin, Kevin Lin, Lin Liang, Lijuan Wang, Junsong Yuan, and Zicheng Liu. Neural voting field for camera-space 3d hand pose estimation. In CVPR, pages 8969-8978, 2023. 1, 2
[26] Umar Iqbal, Pavlo Molchanov, Thomas Breuel Juergen Gall, and Jan Kautz. Hand pose estimation via latent 2.5D heatmap regression. In ECCV, pages 118-134, 2018. 2
[27] Diederik P Kingma. Auto-encoding variational bayes. arXiv preprint arXiv:1312.6114, 2013. 4
[28]P. Diederik Kingma and Lei Jimmy Ba. Adam: A method for stochastic optimization. In ICLR, 2015. 6
[29] Dominik Kulon, Riza Alp Guler, Iasonas Kokkinos, Michael M. Bronstein, and Stefanos Zafeiriou. Weakly supervised mesh-convolutional hand reconstruction in the wild. In CVPR, pages 4990-5000, 2020. 2
[30] Tsung-Yi Lin, Piotr Dollir, Ross Girshick, Kaiming He, Bharath Hariharan, and Serge Belongie. Feature pyramid networks for object detection. In CVPR, pages 2117-2125, 2017. 3
[31] Zhifeng Lin, Changxing Ding, Huan Yao, Zengsheng Kuang, and Shaoli Huang. Harmonious feature learning for interactive hand-object pose estimation. In CVPR, pages 12989-12998,2023.1,2,4,5,6,7,8
[32] Shaowei Liu, Hanwen Jiang, Jiarui Xu, Sifei Liu, and XiaolongWang. Semi-supervised 3D hand-object poses estimation with interactions in time. In CVPR, pages 14687-14697, 2021. 1, 2, 4, 6, 8
[33] Wenquan Lu, Yufei Xu, Jing Zhang, Chaoyue Wang, and Dacheng Tao. Handrefiner: Refining malformed hands in generated images by diffusion-based conditional inpainting. In ACM MM, 2024. 3, 4
[34] Andreas Lugmayr, Martin Danelljan, Andres Romero, Fisher Yu, Radu Timofte, and Luc Van Gool. Repaint: Inpainting using denoising diffusion probabilistic models. In CVPR, pages 11461-11471,2022.4
[35] Matthew Matl. Pyrender. https://github.com/mmatl/pyrender, 2019. 2
[36] Gyeongsik Moon and Kyoung Mu Lee. 12L-MeshNet: Imageto-lixel prediction network for accurate 3D human pose and mesh estimation from a single RGB image. In ECCV, pages 752-768, 2020. 1, 2
[37] Gyeongsik Moon, Shoou-I Yu, He Wen, Takaaki Shiratori, and Kyoung Mu Lee. Interhand2.6M: A dataset and baseline for 3D interacting hand pose estimation from a single RGB image. In ECCV, pages 548-564, 2020. 2
[38] Supreeth Narasimhaswamy, Uttaran Bhattacharya, Xiang Chen, Ishita Dasgupta, Saayan Mitra, and Minh Hoai. Handiffuser: Text-to-image generation with realistic hand appearances. In CVPR, pages 2468-2479, 2024. 3
[39] JoonKyu Park, Yeonguk Oh, Gyeongsik Moon, Hongsuk Choi, and Kyoung Mu Lee. HandOccNet: Occlusion-robust 3D hand mesh estimation network. In CVPR, pages 1496-1505,2022.1,2,6,7,8
[40] Junho Park, Kyeongbo Kong, and Suk-Ju Kang. Attention hand: Text-driven controllable hand image generation for 3d hand reconstruction in the wild. arXiv preprint arXiv:2407.18034, 2024. 3
[41]J Redmon. You only look once: Unified, real-time object detection. In CVPR, 2016. 5
[42] Robin Rombach, Andreas Blattmann, Dominik Lorenz, Patrick Esser, and Bjorn Ommer. High-resolution image synthesis with latent diffusion models. In CVPR, pages 10684-10695, 2022. 2, 4
[43] Jascha Sohl-Dickstein, Eric Weiss, Niru Maheswaranathan, and Surya Ganguli. Deep unsupervised learning using nonequilibrium thermodynamics. In ICML, pages 2256-2265, 2015.
[44] Jiaming Song, Chenlin Meng, and Stefano Ermon. Denoising diffusion implicit models. arXiv preprint arXiv:2010.02502, 2020. 2, 4
[45] Tze Ho Elden Tse, Kwang In Kim, Ales Leonardis, and Hyung Jin Chang. Collaborative learning for hand and object reconstruction with attention-guided graph convolution. In CVPR, pages 1664-1674, 2022. 2, 4
[46] Ashish Vaswani, Noam Shazeer, Niki Parmar, Jakob Uszkoreit, Llion Jones, Aidan N Gomez, Lukasz Kaiser, and Illia Polosukhin. Attention is all you need. NeurIPS, pages 6000-6010, 2017. 4
[47] Rong Wang, Wei Mao, and Hongdong Li. Interacting hand object pose estimation via dense mutual attention. In WACV, pages 5735-5745, 2023. 1
[48] Yinhuai Wang, Jiwen Yu, and Jian Zhang. Zero-shot image restoration using denoising diffusion null-space model. ICLR, 2023. 2
[49] Hao Xu, TianyuWang, Xiao Tang, and Chi-Wing Fu. H2onet: Hand-occlusion-and-orientation-aware network for real-time 3d hand mesh reconstruction. In CVPR, pages 17048-17058,2023.1,2,6,7,8
[50] Hao Xu, Haipeng Li, YingiaoWang, Shuaicheng Liu, and Chi-Wing Fu. Handbooster: Boosting 3d hand-mesh reconstruction by conditional synthesis and sampling of hand-object interactions. In CVPR, pages 10159-10169, 2024. 3
[51] Lixin Yang, Jiasen Li, Wenqiang Xu, Yiqun Diao, and Cewu Lu. BiHand: Recovering hand mesh with multi-stage bisected hourglass networks. In BMVC, 2020. 2
[52] Linlin Yang, Shicheng Chen, and Angela Yao. SemiHand: Semi-supervised hand pose estimation with consistency. In ICCV, pages 11364-11373, 2021. 2
[53] Lixin Yang, Xinyu Zhan, Kailin Li, Wenqiang Xu, Jiefeng Li, and Cewu Lu. Cpf: Learning a contact potential field to model the hand-object interaction. In ICCV, pages 11097-11106,2021.6
[54] Lixin Yang, Kailin Li, Xinyu Zhan, Jun Lv, Wenqiang Xu, Jiefeng Li, and Cewu Lu. Artiboost: Boosting articulated 3d hand-object pose estimation via online exploration and synthesis. In CVPR, pages 2750-2760, 2022. 2
[55] Yufei Ye, Abhinav Gupta, and Shubham Tulsiani. What's in your hands?3d reconstruction of generic objects in hands. In CVPR, pages 3895-3905, 2022. 2
[56] Yufei Ye, Xueting Li, Abhinav Gupta, Shalini De Mello, Stan Birchfield, Jiaming Song, Shubham Tulsiani, and Sifei Liu. Affordance diffusion: Synthesizing hand-object interactions. In CVPR, pages 22479-22489, 2023. 3
[57] Yufei Ye, Abhinav Gupta, Kris Kitani, and Shubham Tulsiani. G-hop: Generative hand-object prior for interaction reconstruction and grasp synthesis. In CVPR, pages 1911-1920, 2024. 2
[58] Baowen Zhang, Yangang Wang, Xiaoming Deng, Yinda Zhang, Ping Tan, Cuixia Ma, and Hongan Wang. Interacting two-hand 3D pose and shape reconstruction from single color image. In ICCV, pages 11354-11363, 2021. 2
[59] Lvmin Zhang, Anyi Rao, and Maneesh Agrawala. Adding conditional control to text-to-image diffusion models. In ICCV, pages 3836-3847, 2023. 4
[60] Mengqi Zhang, Yang Fu, Zheng Ding, Sifei Liu, Zhuowen Tu, and Xiaolong Wang. Hoidiffusion: Generating realistic 3d hand-object interaction data. In CVPR, pages 8521-8531, 2024. 3
[61] Xiong Zhang, Qiang Li, Hong Mo, Wenbo Zhang, and Wen Zheng. End-to-end hand mesh recovery from a monocular RGB image. In ICCV, pages 2354-2364, 2019. 2
[62] Xiong Zhang, Hongsheng Huang, Jianchao Tan, Hongmin Xu, Cheng Yang, Guozhu Peng, Lei Wang, and Ji Liu. Handimage understanding via deep multi-task learning. In ICCV, pages 11281-11292, 2021.
[63] Zimeng Zhao, Xi Zhao, and Yangang Wang. TravelNet: Self-supervised physically plausible hand motion learning from monocular color images. In ICCV, pages 11666-11676, 2021.
[64] Yuxiao Zhou, Marc Habermann, Weipeng Xu, Ikhsanul Habibie, Christian Theobalt, and Feng Xu. Monocular real-time hand shape and motion capture using multi-modal data. In CVPR, pages 5346-5355, 2020. 2
[65] Zhishan Zhou, Shihao Zhou, Zhi Lv, Minqiang Zou, Yao Tang, and Jiajun Liang. A simple baseline for efficient hand mesh reconstruction. In CVPR, pages 1367-1376, 2024. 1, 2, 6, 8
[66] Christian Zimmermann, Duygu Ceylan, Jimei Yang, Bryan Russell, Max Argus, and Thomas Brox. FreiHAND: A dataset for markerless capture of hand pose and shape from single RGB images. In ICCV, pages 813-822, 2019. 2, 6.

We claim:

1. A unified method for hand-object pose estimation based on monocular RGB images, comprising:
predicting, by an object switcher, a grasping status of an object in an input image to provide flexibility across different scenes;
performing adaptive grasp-aware feature fusion for hand-object features to configure effective object information based on the grasping status to maintain robust feature representation for hands;
performing generative de-occluding that is a conditional generative step to synthesize plausible de-occluded hand images as pairs for training samples affected by object-induced occlusions, with adaptive adjustment of control strength to produce high-quality samples; and
performing multi-level feature enhancement that is a feature learning step that imposes pair-wise constraints between original occluded and generated non-occluded features at multiple levels to promote the network to learn occlusion-invariant features, enabling robust hand pose estimation against severe occlusions.

2. The method of claim 1, wherein the object switcher is a lightweight multi-layer perceptron (MLP) that feeds in object features.

3. The method of claim 2, wherein the object features are extracted by a Feature Pyramid Network (FPN) from the input image.

4. The method of claim 2, wherein a training process is supervised according to a binary cross-entropy loss with respect to ground-truth grasping labels.

5. The method of claim 2, wherein during a testing process, an object pose estimation branch is deactivated if it is predicted as non-grasping.

6. The method of claim 1, wherein the performing adaptive grasp-aware feature fusion comprises mitigating interference from irrelevant features by configuring most pertinent object features for enhancing hand representations.

7. The method of claim 6, wherein the object features and the hand features produced by a region of interest align (RoIAlign) operation are concatenated only when the object is predicted as grasped.

8. The method of claim 7, wherein the concatenated features are processed through a multi-head attention block to generate fused hand-object features for subsequent network to regress three-dimensional (3D) hand poses.

9. The method of claim 1, wherein the performing generative de-occluding comprises synthesizing plausible de-occluded hand images as pairs for training samples affected by object-caused occlusions.

10. The method of claim 9, wherein the performing generative de-occluding further comprises performing an adaptive adjustment method for control strength to maximize generation quality.

11. The method of claim 1, wherein during a training process, the performing multi-level feature enhancement comprises imposing pair-wise constraints between original occluded and generated non-occluded features at three different levels.

12. The method of claim 11, wherein the three different levels include an initial level, a region of interest (RoI) level, and a MANO (hand Model with Articulated and Non-rigid defOrmations) level to promote the network to simulate occlusion-invariant features via self-distillation, enabling a robust performance of hand pose estimation against object-caused occlusion during a testing process.

13. A unified system for hand-object pose estimation based on monocular RGB images, comprising:
an object switcher module configured to predict a grasping status of an object in an input image to provide flexibility across different scenes;
an adaptive grasp-aware feature fusion module configured for hand-object features to obtain effective object information based on the grasping status to maintain robust feature representation for hands;
a generative de-occluding module configured to synthesize plausible de-occluded hand images as pairs for training samples affected by object-induced occlusions, with adaptive adjustment of control strength to produce high-quality samples; and
a multi-level feature enhancement module configured to impose pair-wise constraints between original occluded and generated non-occluded features at multiple levels to promote the network to learn occlusion-invariant features, enabling robust hand pose estimation against severe occlusions.

14. The system of claim 13, wherein the object switcher module is a lightweight multi-layer perceptron (MLP) that feeds in object features.

15. The system of claim 14, wherein the object features are extracted by a Feature Pyramid Network (FPN) from the input image.

16. The system of claim 14, wherein the training process is supervised based on binary cross-entropy loss with respect to ground-truth grasping labels.

17. The system of claim 14, wherein during a testing process an object pose estimation branch is deactivated if it is predicted as non-grasping.

18. The system of claim 13, wherein the performing adaptive grasp-aware feature fusion module comprises mitigating interference from irrelevant features by configuring most pertinent object features for enhancing hand representations.

19. The system of claim 18, wherein the object features and the hand features produced by a region of interest align (RoIAlign) operation are concatenated only when the object is predicted as grasped.

20. The system of claim 19, wherein the concatenated feature is processed through a multi-head attention block to generate fused hand-object features for subsequent network to regress three-dimensional (3D) hand poses.
